(19) United States
(12) Patent Application Publication
(10) Pub. No.: US 2023/0061626 A1
(43) Pub. Date: Mar. 2, 2023

(54) DATA PROCESSING SYSTEM AND OPERATION METHOD THEREOF

(71) Applicant: SK hynix Inc., Gyeonggi-do (KR)

(72) Inventor: Jung Woo KIM, Gyeonggi-do (KR)

(21) Appl. No.: 17/579,117

(22) Filed: Jan. 19, 2022

(30) Foreign Application Priority Data
Aug. 31, 2021 (KR) 10-2021-0115638

(51) Int. Cl. G06F 3/06

(52) U.S. Cl. CPC G06F 3/0616; G06F 3/064; G06F 3/0619; G06F 3/0652; G06F 3/0659; G06F 3/0679

(57) ABSTRACT

A data processing system comprises: a memory system including an available area and a bad area, and a host configured to: determine a life expectancy of the memory system according to a current user capacity in the available area on the basis of storage area information received from the memory system, determine a new user capacity of the memory system on the basis of a requested life expectancy of the memory system, and provide information on the new user capacity to the memory system thereby controlling the memory system to reset the user capacity and an overprovisioning capacity in the available area according to the new user capacity.

### CROSS REFERENCE TO RELATED APPLICATION

This application claims priority under 35 U.S.C. §119 to Korean Patent Application No. 10-2021-0115638 filed on Aug. 31, 2021, which is incorporated herein by reference in its entirety.

### BACKGROUND

### 1. Field

Various embodiments of the present disclosure relate to a data processing system and an operation method thereof.

### 2. Discussion of the Related Art

Recently, a computer environment paradigm has shifted to ubiquitous computing, which enables a computer system to be accessed anytime and everywhere. As a result, the use of portable electronic devices such as mobile phones, digital cameras, notebook computers and the like has increased. Such portable electronic devices typically use or include a memory system that uses or embeds at least one memory device, i.e., a data storage device. The data storage device can be used as a main storage device or an auxiliary storage device of a portable electronic device.

In a computing device, unlike a hard disk, a data storage device implemented as a nonvolatile semiconductor memory device is advantageous in that it has excellent stability and durability because it has no mechanical driving part (e.g., a mechanical arm), and has high data access speed and low power consumption. Examples of such a data storage device include a universal serial bus (USB) memory device, a memory card having various interfaces, and a solid state drive (SSD).

### SUMMARY

Various embodiments of the present disclosure are directed to providing a data processing system capable of increasing the life of a memory system and an operation method thereof.

In accordance with an embodiment of the present disclosure, a data processing system may include: a memory system including an available area and a bad area; and a host configured to: determine a life expectancy of the memory system according to a current user capacity in the available area on the basis of storage area information received from the memory system, determine a new user capacity of the memory system on the basis of a requested life expectancy of the memory system, and provide information on the new user capacity to the memory system thereby controlling the memory system to reset the user capacity and an overprovisioning capacity in the available area according to the new user capacity.

In accordance with an embodiment of the present disclosure, an operation method of a data processing system, the operation method may include: determining a life expectancy of a memory system according to a current user capacity in an available area of the memory system on the basis of storage area information from the memory system; determining a new user capacity on the basis of a requested life expectancy of the memory system; and resetting a user capacity and an overprovisioning capacity in the available area according to the new user capacity.

In accordance with an embodiment of the present disclosure, a memory system may include: a memory device including memory blocks divided into an available area and a bad area; and a controller configured to: check an average block usage of the memory device in a predetermined period by monitoring an amount of data received from a host and an amount of data programmed into the memory device by a background operation of the memory device, check a sum of block durability of the memory device on the basis of a maximum program/erase (P/E) cycle and a current P/E cycle of memory blocks included in the available area, and determine a life expectancy of the memory device according to a current user capacity in the available area on the basis of the sum of the block durability and the average block usage.

In accordance with an embodiment of the present disclosure, an operating method of a host, the operating method may include: gathering information of a sum of block durability, an average block usage and a current user capacity of a memory device; receiving, from a user, information of a life expectancy of the memory device; and downsizing the current user capacity to an adjusted user capacity defined by a following equation, [Equation] U = (B*C) / (A*L), where ‘U’ represents the adjusted user capacity, ‘A’ represents the average block usage, ‘B’ represents the sum of block durability, ‘C’ represents the current user capacity and ‘L’ represents the life expectancy.

The present disclosure provides a data processing system capable of increasing the life of a memory system and an operation method thereof.

### BRIEF DESCRIPTION OF THE DRAWINGS

FIG. 1 is a diagram schematically illustrating an example of a data processing system including a memory system in accordance with an embodiment of the present disclosure.

FIG. 2 is a detailed diagram for describing a controller described with reference to FIG. 1 in accordance with an embodiment of the present disclosure.

FIG. 3 schematically illustrates a storage space of a memory device in accordance with an embodiment of the present disclosure.

FIG. 4 illustrates an interaction between a host and a memory system in accordance with an embodiment of the present disclosure.

FIG. 5 is a diagram for describing life expectancy according to a user capacity in accordance with an embodiment of the present disclosure.

FIG. 6 illustrates life expectancy information according to a user capacity that a host may provide a user in accordance with an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in "one embodiment," "example embodiment," "an embodiment," "another embodiment," "some embodiments," "various embodiments," "other embodiments," "alternative embodiment," and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware-for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

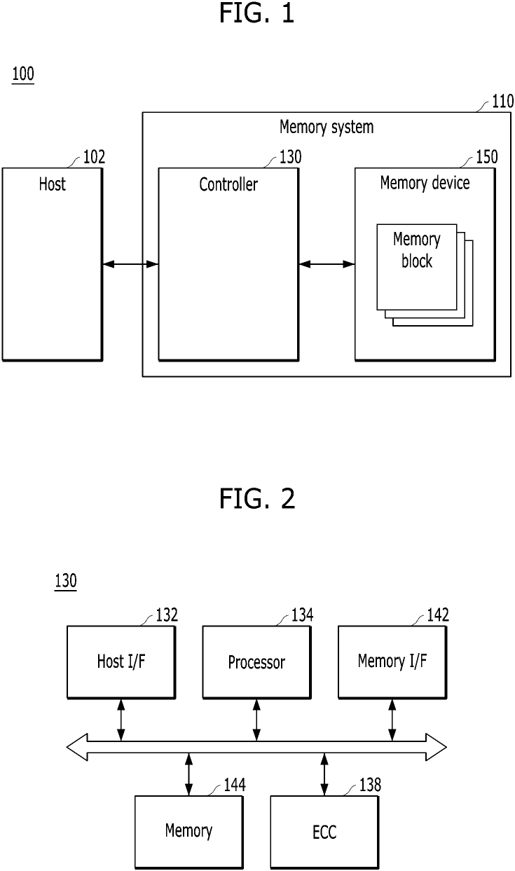

Referring to FIG. 1, the data processing system 100 may include a host 102 engaged or operably coupled with the memory system 110.

The host 102 may include any of a portable electronic device, such as a mobile phone, an MP3 player, a laptop computer, or the like, and an electronic device, such as a desktop computer, a game player, a television (TV), a projector, or the like.

The host 102 also includes at least one operating system (OS), which can generally manage and control, functions and operations performed in the host 102. The OS can provide interoperability between the host 102 engaged with the memory system 110 and the user using the memory system 110. The OS may support functions and operations corresponding to a user’s requests. By way of example but not limitation, the OS can be classified into a general operating system and a mobile operating system according to mobility of the host 102. The general operating system may be split into a personal operating system and an enterprise operating system according to system requirements or a user’s environment. The personal operating system, including Windows and Chrome, may be subject to support services for general purposes. But the enterprise operating systems can be specialized for securing and supporting high performance, including Windows servers, Linux, Unix, and the like. Further, the mobile operating system may include Android, iOS, Windows mobile, and the like. The mobile operating system may be subject to support services or functions for mobility (e.g., a power saving function). The host 102 may include a plurality of operating systems. The host 102 may execute multiple operating systems interlocked with the memory system 110, corresponding to a user’s request. The host 102 may transmit a plurality of commands corresponding to the user’s requests into the memory system 110, thereby performing operations corresponding to commands within the memory system 110.

The storage devices for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and a flash memory.

The memory system 110 may include a controller 130 and a memory device 150. The memory device 150 may store data to be accessed by the host 102. The controller 130 may control an operation of storing data in the memory device 150.

The controller 130 and the memory device 150 included the memory system 110 may be integrated into a single semiconductor device, which may be included in any of the various types of memory systems as discussed above in the examples.

By way of example but not limitation, the controller 130 and memory device 150 may be implemented with an SSD. When the memory system 110 is used as an SSD, the operating speed of the host 102 connected to the memory system 110 can be improved more than that of the host 102 implemented with a hard disk. In addition, the controller 130 and the memory device 150 may be integrated into one semiconductor device to form a memory card, such as a PC card (PCMCIA), a compact flash card (CF), a memory card such as a smart media card (SM, SMC), a memory stick, a multimedia card (MMC, RS-MMC, MMCmicro), a SD card (SD, miniSD, microSD, SDHC), a universal flash memory, or the like.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even while electrical power is not supplied. The memory device 150 may store data provided by the host 102 through a write operation and provide data stored therein to the host 102 through a read operation. The memory device 150 may include a plurality of memory blocks, each of which may include a plurality of pages. Each of the plurality of pages may include a plurality of memory cells to which a corresponding one of a plurality of word lines (WL) is coupled. In addition, the memory device 150 may be a flash memory, and the flash memory may have a three-dimensional stack structure.

The controller 130 in the memory system 110 may control the memory device 150 in response to a request from the host 102. For example, the controller 130 may provide data read from the memory device 150, to the host 102, and may store data provided from the host 102, in the memory device 150. To this end, the controller 130 may control read, write, program, and erase operations of the memory device 150.

The life of the memory device 150 may be limited. For example, when programming and erasing are repeated in the memory blocks included in the memory device 150, the memory blocks may reach their end of life. Data may not be normally programmed to a memory block having reached its end of life. A memory block, in which a program fail occurs due to the end of life, may be referred to as a bad block. The controller 130 may store bad block information indicating which memory block is a bad block, and may restrict access to a bad block by using the bad block information.

As the memory device 150 is used, the number of bad blocks may increase and the number of normal blocks may decrease. When data is programmed to all normal blocks, data may no longer be programmed to the memory device 150 and the memory device 150 may reach its end of life. Hereinafter, a method capable of increasing the life expectancy of the memory device 150 in spite of a decrease in the number of normal blocks is proposed.

In accordance with an embodiment of the present disclosure, the memory system 110 may increase the lifespan of the memory device 150 by reducing the size of a storage space accessible by the host 102. The size of the storage space accessible by the host 102 may be referred to as a user capacity.

The host 102 may determine a life expectancy of the memory device 150 according to the current user capacity of the memory device 150 on the basis of information acquired from the memory system 110, determine a new user capacity of the memory device 150 on the basis of requested life expectancy of the memory device 150, and provide information on the new user capacity to the memory system 110. In this disclosure, a requested life expectancy means a life expectancy requested or inputted from a user. The memory system 110 may increase the life of the memory device 150 by reducing the user capacity on the basis of the information on the new user capacity received from the host 102. Hereinafter, the memory system 110 and the data processing system 100 in accordance with an embodiment of the present disclosure will be described in detail with reference to FIG. 2 to FIG. 6.

FIG. 2 is a detailed diagram for describing the controller 130 described with reference to FIG. 1 in accordance with an embodiment of the present disclosure.

The controller 130 may include a host interface (I/F) 132, a processor 134, an error correction code (ECC) 138, a memory interface (I/F) 142, and a memory 144 operably connected to each other through an internal bus.

The host interface 132 may process commands and data provided by the host 102, and may communicate with the host 102 through at least one of various communication standards or interfaces such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI), and integrated drive electronics (IDE). In accordance with an embodiment, the host interface 132 is a component for exchanging data with the host 102, which may be implemented through firmware called a host interface layer (HIL).

The ECC component 138 can correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. After performing error correction decoding on the data read from the memory device 150, the ECC component 138 can determine whether the error correction decoding has succeeded and output an instruction signal (e.g., a correction success signal or a correction fail signal). The ECC component 138 can use the parity bit which is generated during the ECC encoding process, for correcting the error bit of the read data. When the number of the error bits is greater than or equal to a threshold number of correctable error bits, the ECC component 138 might not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC component 138 may include any and all circuits, modules, systems or devices for performing the error correction operation based on at least one of the above described codes.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 when the memory device 150 is a flash memory and, in particular, when the memory device 150 is a NAND flash memory. The memory interface 142 can provide an interface for handling commands and data between the controller 130 and the memory device 150, for example, operations of NAND flash interface, in particular, operations between the controller 130 and the memory device 150. In accordance with an embodiment, the memory interface 142 can be implemented through firmware called a Flash Interface Layer (FIL) as a component for exchanging data with the memory device 150.

The memory 144 may support operations performed by the memory system 110 and the controller 130. The memory 144 may store temporary or transactional data which occurred or was delivered for operations in the memory system 110 and the controller 130. The controller 130 may control the memory device 150 in response to a request from the host 102. The controller 130 may deliver data read from the memory device 150 into the host 102. The controller 130 may store data entered through the host 102 within the memory device 150. The memory 144 may be used to store data for the controller 130 and the memory device 150 in order to perform operations such as read operations or program/write operations or erase operation.

When the controller 130 controls read, write, program, and erase operations of the memory device 150, data to be transferred or generated between the controller 130 and the memory device 150 in the memory system 110 may be stored in the memory 144. For example, the memory 144 may store data necessary to perform data write and read operations between the host 102 and the memory device 150 and data when performing the data write and read operations. For such data storage, the memory 144 may include a program memory, a data memory, a write buffer/cache, a read buffer/cache, a data buffer/cache, a map buffer/cache, and so forth.

The memory 144 may be realized by a volatile memory. For example, the memory 144 may be realized by a static random access memory (SRAM) or a dynamic random access memory (DRAM). The memory 144 may exist inside the controller 130 as illustrated in the drawing. Alternatively, the memory 144 may exist outside the controller 130 unlike the illustration of the drawing. In this case, the memory 144 may be realized as an external volatile memory to and from which data is inputted and outputted from and to the controller 130 through a separate memory interface.

The processor 134 controls the entire operations of the memory system 110. In particular, the processor 134 controls a program operation or a read operation for the memory device 150, in response to a write request or a read request from the host 102. The processor 134 drives firmware which is referred to as a flash translation layer (FTL), to control general operations of the memory system 110. The processor 134 may be realized by a microprocessor or a central processing unit (CPU).

For instance, the controller 130 performs an operation requested from the host 102, in the memory device 150. That is, the controller 130 performs a command operation corresponding to a command received from the host 102, with the memory device 150, through the processor 134 embodied by a microprocessor or a central processing unit (CPU). The controller 130 may perform a foreground operation as a command operation corresponding to a command received from the host 102. For example, the controller 130 may perform a program operation corresponding to a write command, a read operation corresponding to a read command, an erase operation corresponding to an erase command, or a parameter set operation corresponding to a set parameter command or a set feature command as a set command.

The controller 130 may also perform a background operation for the memory device 150, through the processor 134 embodied by a microprocessor or a central processing unit (CPU). The background operation for the memory device 150 may include an operation of copying data stored in a memory block among the memory blocks of the memory device 150 to another memory block, for example, a garbage collection (GC) operation. The background operation may include an operation of swapping data between one or more of the memory blocks of the memory device 150, for example, a wear leveling (WL) operation and a read reclaim (RR) operation. The background operation may include an operation of storing map data retrieved from the controller 130 in the memory blocks of the memory device 150, for example, a map flush operation. The background operation may include a bad management operation for the memory device 150, which may include checking for and processing a bad block among the plurality of memory blocks in the memory device 150.

The processor 134 may effectively suppress access to the memory device 150 by managing the storage space of the memory device 150 at the request of the host 102, and increase as much life expectancy as the host 102 requires.

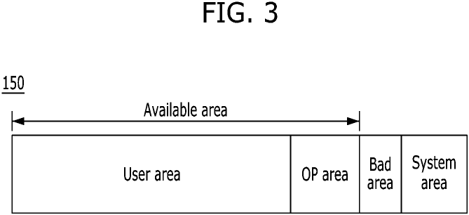

FIG. 3 schematically illustrates the storage space of the memory device 150 in accordance with an embodiment of the present disclosure.

The memory device 150 may include a user area, an overprovisioning (OP) area, a system area, and a bad area. Each area may include memory blocks. In FIG. 3, one area is illustrated as one lump, but memory blocks included in one area are not necessarily physically continuous.

The bad area may include bad blocks. As the memory device 150 is used, the size of the bad area may increase. The user area, the OP area, and the system area may each include normal blocks.

The user area may store user data provided from the host 102. That is, the user area may correspond to a logical address space accessible by the host 102. The user area may include an area where data is stored and an area where no data is stored. The size of the user area corresponds to a user capacity, and the size of the area, where data is stored, in the user area may be referred to as an occupied capacity.

The system area may store system data. The system data may include map data indicating mapping between a logical address of the host 102 and a physical address of the memory device 150, booting data for booting the memory system 110, and the like.

The OP area may be a free space for facilitating a background operation such as a garbage collection operation.

The user area and the OP area may be collectively referred to as an available area. As the size of the bad area increases, the size of the available area may decrease. In order to normally use the memory system 110 in spite of a decrease in the size of the available area, the host 102 may change the user capacity and the size of the OP area.

In accordance with an embodiment of the present disclosure, the controller 130 may adjust a size occupied by the user area and the OP area in the available area, at the request of the host 102. Specifically, the host 102 may determine a life expectancy of the memory device 150 according to a current user capacity of the memory device 150 on the basis of information acquired from the memory system 110, and determine a new user capacity of the memory device 150 on the basis of requested life expectancy of the memory device 150. For example, the host 102 may provide a user with various possible life expectancy information according to possible user capacities. The user may change the user capacity of the memory device 150 by requesting an expanded life expectancy of the memory device 150. The host 102 may receive the requested life expectancy from the user, determine a new user capacity of the memory device 150 based on the requested life expectancy and provide information of the new user capacity to the memory system 110. The memory system 110 may reset the user area and the OP area on the basis of the new user capacity information.

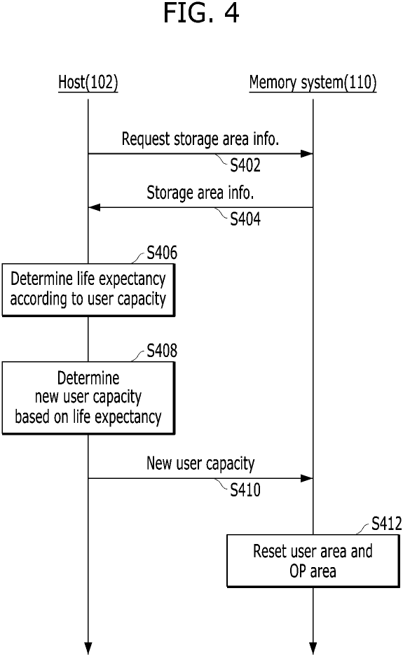

The operation of the data processing system 100 in accordance with an embodiment of the present disclosure will be described in detail with reference to FIG. 4 to FIG. 6.

FIG. 4 illustrates an interaction between the host 102 and the memory system 110 in accordance with an embodiment of the present disclosure.

In operation S402, the host 102 may request storage area information from the memory system 110.

The storage area information may refer to information for the host 102 to determine the life expectancy of the memory device 150 according to the user capacity of the memory device 150. For example, the storage area information may include current user capacity information, block usage information, and block durability information of memory blocks, and may further include occupied capacity information.

The block durability may refer to life of use in which the reliability of the memory block can be guaranteed, and the block usage may refer to the amount of data programmed to the memory device 150 in a predetermined period.

In operation S404, the memory system 110 may provide the storage area information to the host 102 in response to the request of the host 102.

The controller 130 may store the program/erase (P/E) cycle of the memory blocks in order to determine the block durability of the memory blocks. A maximum P/E cycle, in which the reliability of data stored in each memory block can be guaranteed, may be determined in advance. The controller 130 may determine the block durability of the memory blocks on the basis of a maximum P/E cycle and a current P/E cycle of memory blocks allocated to the available area. For example, when the maximum P/E cycle of a first memory block is 100 cycles and the first memory block is erased 90 times so far, the block durability of the first memory block may be determined as 10 cycles.

The controller 130 may monitor the amount of data received from the host 102 in order to determine block usage, and monitor the amount of data programmed by the background operation. The controller 130 may determine the sum of the amount of data received from the host 102 in a predetermined period and the amount of data programmed by the background operation in the predetermined period, as block usage for the predetermined period.

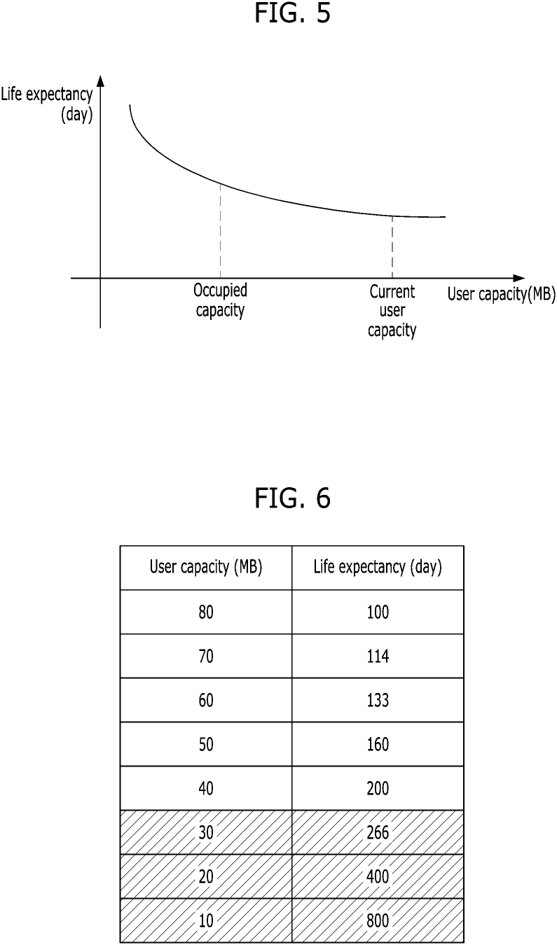

In operation S406, the host 102 may determine the life expectancy of the memory device 150 according to the current user capacity of the memory device 150 on the basis of the storage area information. Operation S406 will be described in detail with reference to FIG. 5 and FIG. 6.

FIG. 5 is a diagram for describing the life expectancy according to the user capacity in accordance with an embodiment of the present disclosure.

In the graph illustrated in FIG. 5, a horizontal axis may denote the user capacity in MB units and a vertical axis may denote the life expectancy in days. As the controller 130 reduces the user capacity, the life expectancy may be increased. Specifically, when the user capacity is reduced, the amount of user data that can be stored is reduced. Thus, the amount of user data received from the host 102 may also be reduced, and the amount of data programmed may also be reduced due to an internal background operation. That is, block usage may be reduced. When the block usage is reduced, the rate at which block durability is reduced, is slowed down, so the life expectancy may be increased.

In accordance with an embodiment of the present disclosure, the host 102 may determine the life expectancy of the memory device 150 according to the current user capacity of the memory device 150 on the basis of Equation 1 below.

### Equation 1

life expectancy=sum of block durability/average block usage×current user capacity/user capacity to be changed

In Equation 1 above, the sum of the block durability may indicate the sum of block durability of memory blocks allocated to the available area.

For example, a current user capacity received from the controller 130 may be 80 MB, the sum of block durability may be 100 cycles , and daily average block usage may be 0.5 cycles. The fact that the sum of block durability is 100 cycles may indicate that the amount of data, which can be further programmed to the memory device 150 while the reliability of the memory device 150 is ensured corresponds to the amount of 100 memory blocks. The fact that the daily average block usage is 0.5 cycles may indicate that data corresponding to half of a memory block are programmed to the memory device 150 on average every day. When the current user capacity is maintained in the memory device 150, the memory device 150 may be used for about 200 days and then reach its end of life. As described above, the life expectancy according to the current user capacity may be determined according to equation 1 when putting a value of the current user capacity also into the item of ‘user capacity to be changed’ in equation 1. That is, the life expectancy according to the current user capacity may be determined according to equation 1 by regarding the user capacity to be changed as the current user capacity.

The host 102 may determine the life expectancy of the memory device 150 according to the current user capacity of the memory device 150 on the basis of the current user capacity, the sum of block durability, and the daily average block usage. When a user reduces the user capacity to 40 MB, that is, half of the current user capacity, the daily average block usage may be reduced to half of the current level. That is, when the user capacity is changed to 40 MB, the life expectancy of the memory device 150 may be increased to 400 days.

Moreover, the current user capacity and occupied capacity are illustrated on the horizontal axis in FIG. 5.

Referring to FIG. 5, when the user capacity of the memory device 150 becomes higher than the current user capacity, the life expectancy may be reduced, and when the user capacity of the memory device 150 becomes lower than the current user capacity, the life expectancy may be increased. As the user capacity is set to be low, the life expectancy may be increased, but when the user capacity is set to be lower than the occupied capacity, user data stored in the memory device 150 may be lost. The host 102 may determine a new user capacity on the basis of requested life expectancy and whether to retain user data.

The host 102 may provide a user interface so that the user may select user capacity by referring to life expectancy information. The user interface may provide the user with life expectancy information according to a user capacity to be changed.

FIG. 6 illustrates life expectancy information according to a user capacity that a host may provide the user in accordance with an embodiment of the present disclosure.

Depending on the implementation, the host 102 may provide the user with various possible life expectancy information according to possible user capacities equal to or less than the current user capacity so that the user may increase the life expectancy of the memory system 110. The user may select, as a user capacity to be changed, one of the possible user capacities by referring to the life expectancy information. For example, when the user wants the reliability of the memory system 110 to be guaranteed for 150 days or more, the user may select a user capacity of 50 MB or less.

The host 102 may allow the user to select whether to retain or delete user data stored in the memory device 150. For example, the host 102 may receive, from the user, selection information on whether to retain or delete the user data stored in the memory device 150.

When the user selects that the user data is retained, the host 102 may allow the user to select one of possible user capacities within the range from the occupied capacity to the current user capacity. For example, when receiving the selection information on the retention of the user data from the user, the host 102 may provide the user with relationship information on possible life expectancies and corresponding user capacities within the range from the occupied capacity to the current user capacity, and the user may select one of the possible user capacities within the range from the occupied capacity to the current user capacity.

On the other hand, when the user selects that the user data is deleted, the host 102 may allow the user to select one of possible user capacities less than the occupied capacity. For example, when receiving the selection information on the deletion of the user data from the user, the host 102 may provide the user with relationship information on possible life expectancies and corresponding user capacities below the occupied capacity and the user may select one of the possible user capacities below the occupied capacity.

In FIG. 6, when the occupied capacity is 30 MB and the current user capacity is 80 MB, a hatched area indicates the possible life expectancy according to the possible user capacity below the occupied capacity, and a non-hatched area indicates the possible life expectancy according to the possible user capacity within the range from the occupied capacity to the current user capacity. Accordingly, when the user selects to retain the user data, the host 102 may provide the user with relationship information on the possible user capacities and corresponding life expectancies in the non-hatched area. On the other hand, when the user selects to delete the user data, the host 102 may provide the user with relationship information on the possible user capacities and corresponding life expectancies in the hatched area as well as the non-hatched area.

Referring back to FIG. 4, in operation S408, the host 102 may determine a new user capacity on the basis of the requested life expectancy input from the user. As a first example, the host 102 may allow the user to input, as a new user capacity, the selected user capacity by referring to the life expectancy according to the user capacity. As a second example, when the user inputs requested life expectancy, the host 102 may determine a new user capacity according to the requested life expectancy.

In operation S410, the host 102 may control the memory system 110 to change the user capacity by providing the new user capacity information to the memory system 110. The host 102 may provide the memory system 110 with information regarding whether to retain the user data stored in the memory device 150.

In operation S412, the memory system 110 may reset the user capacity and the overprovisioning capacity in the available area of the memory system 110 on the basis of the new user capacity information received from the host 102. For example, when the available capacity is 100 MB and the new user capacity received from the host 102 is 40 MB, the memory system 110 may set the user capacity to 40 MB and set the overprovisioning capacity to 60 MB.

When it is determined to delete the user data of the memory device 150, the controller 130 may empty the user area of the memory device 150, and change the size of the logical address space according to the changed user capacity. The controller 130 may change the size of the logical address space by adjusting the range of a logical address accessible by the host 102. For example, the controller 130 may expand the size of the logical address space by expanding the range of the logical address accessible by the host 102.

When it is determined to retain the user data of the memory device 150, the controller 130 may change the size of the logical address space in a state in which the user data is stored in the memory device 150. The controller 130 may change the size of the logical address space by adjusting the range of the logical address accessible by the host 102. For example, the controller 130 may reduce the size of the logical address space by reducing the range of the logical address accessible by the host 102.

The controller 130 may update mapping between a logical address and a physical address of the user data while adjusting the range of the logical address, and store map data indicating the updated mapping in the system area of the memory device 150.

In accordance with an embodiment of the present disclosure, the host 102 may determine life expectancy according to a user capacity on the basis of storage area information received from the memory system 110, and provide information on the life expectancy to a user. The host 102 may provide the memory system 110 with new user capacity information determined on the basis of requested life expectancy. In accordance with an embodiment of the present disclosure, the memory system 110 may increase its own life expectancy in response to a request of the host 102.

Moreover, the operation of the host 102 related to the life expectancy may also be performed by the controller 130 included in the memory system 110, and the specific operation of the controller 130 related to the life expectancy may be the same as the operation of the host 102 related to the life expectancy and described above.

In accordance with an embodiment of the present disclosure, the operation of the host 102, which determines life expectancy according to a user capacity in the available area on the basis of storage area information checkable in the memory system 110, may also be performed in the memory system 110. That is, the controller 130 included in the memory system 110 may check the user capacity in the available area, monitor the amount of data received from the host 102 and the amount of data programmed by a background operation to check average block usage for a predetermined period, check the sum of block durability of memory blocks included in the available area on the basis of a maximum program/erase (P/E) cycle and a current P/E cycle of the memory blocks included in the available area, and then calculate life expectancy according to a user capacity on the basis of the check result.

In this way, when the memory system 110 calculates the life expectancy according to the user capacity, the host 102 may provide a user with life expectancy information according to the user capacity acquired from the memory system 110.

Furthermore, the host 102 may receive, from a user, selection information on whether to retain or delete user data stored in the available area, and transmit the selection information received from the user to the memory system 110.

In this way, when receiving the user’s selection information through the host 102, the memory system 110 may determine a new user capacity on the basis of the selection information transmitted through the host 102, and reset a user capacity and an overprovisioning capacity in the available area on the basis of the determined new user capacity.

Although a data processing system and an operation method thereof in accordance with an embodiment of the present disclosure have been described as specific embodiments, these are merely examples, and the present disclosure is not limited thereto and should be construed as having the widest range based on the basic idea disclosed in the present specification. Those skilled in the art may carry out unspecified embodiments by combining and replacing the disclosed embodiments, without departing from the scope of the present disclosure. In addition, those skilled in the art may easily change or modify the disclosed embodiments based on the present specification, and it is apparent that such changes or modifications also fall within the scope of the present disclosure and the following claims. Furthermore, the embodiments may be combined to form additional embodiments.

What is claimed is:

1. A data processing system comprising:
a memory system including an available area and a bad area; and
a host configured to:
determine a life expectancy of the memory system according to a current user capacity in the available area on the basis of storage area information received from the memory system,
determine a new user capacity of the memory system on the basis of a requested life expectancy of the memory system, and
provide information on the new user capacity to the memory system thereby controlling the memory system to reset the user capacity and an overprovisioning capacity in the available area according to the new user capacity.

2. The data processing system of claim 1, wherein the storage area information includes information of the current user capacity, an average block usage, and a sum of block durability of memory blocks.

3. The data processing system of claim 2,
wherein the host determines the life expectancy according to the current user capacity on the basis of the sum of block durability and the average block usage, and
wherein the host determines the new user capacity on the basis of the current user capacity, the sum of block durability, the average block usage and the requested life expectancy.

4. The data processing system of claim 2, wherein the memory system is configured to check the average block usage in a predetermined period on the basis of an amount of data received from the host and an amount of data programmed by a background operation.

5. The data processing system of claim 2, wherein the memory system is configured to determine the block durability on the basis of a maximum program/erase (P/E) cycle and a current P/E cycle of memory blocks included in the available area.

6. The data processing system of claim 2, wherein the storage area information further includes information of an occupied capacity that is a size of an area where user data is stored within the available area.

7. The data processing system of claim 6, wherein the host is further configured to:
receive, from a user, selection information on whether to retain or delete the user data stored in the available area, and
provide, according to the selection information, the user with various relationship information of possible user capacities and corresponding life expectancies of the memory system.

8. The data processing system of claim 7,
wherein, when receiving the selection information to retain the user data, the host provides the user with the relationship information of the possible user capacities within a range of the current user capacity and the occupied capacity, and
wherein, when receiving the selection information to delete the user data, the host provides the user with the relationship information of the possible user capacities within a range of the current user capacity and a capacity less than the occupied capacity.

9. The data processing system of claim 2, wherein the memory system is configured to:
adjust a range of logical addresses accessible by the host on the basis of the information on the new user capacity, and
update mapping of a logical address and a physical address of user data.

10. The data processing system of claim 9,
wherein the memory system further includes a system area, and
wherein the memory system is further configured to store map data indicating the updated mapping in the system area.

11. An operation method of a data processing system, the operation method comprising:
determining a life expectancy of a memory system according to a current user capacity in an available area of the memory system on the basis of storage area information from the memory system;
determining a new user capacity on the basis of a requested life expectancy of the memory system; and
resetting a user capacity and an overprovisioning capacity in the available area according to the new user capacity.

12. The operation method of claim 11, wherein the storage area information includes information of the current user capacity, an average block usage, and a sum of block durability of memory blocks.

13. The operation method of claim 12,
wherein the life expectancy is determined according to the current user capacity on the basis of the sum of block durability and the average block usage, and
wherein the new user capacity is determined on the basis of the current user capacity, the sum of block durability, the average block usage and the requested life expectancy.

14. The operation method of claim 12, further comprising checking the average block usage in a predetermined period on the basis of an amount of data received in the memory system and an amount of data programmed to the memory system by a background operation.

15. The operation method of claim 12, further comprising determining the block durability on the basis of a maximum program/erase (P/E) cycle and a current P/E cycle of memory blocks included in the available area.

16. The operation method of claim 12, wherein the storage area information further includes information of an occupied capacity that is a size of an area where user data is stored within the available area.

17. The operation method of claim 16, further comprising:
receiving, from a user, selection information on whether to retain or delete the user data stored in the available area; and
providing, according to the selection information, the user with various relationship information of possible user capacities and corresponding life expectancies of the memory system.

18. The operation method of claim 16,
wherein the possible user capacities are within a range of the current user capacity and the occupied capacity when receiving the selection information to retain the user data, and
wherein the possible user capacities are within a range of the current user capacity and a capacity less than the occupied capacity when receiving the selection information to delete the user data.

19. The operation method of claim 12, further comprising:
adjusting a range of an accessible logical address on the basis of the information on the new user capacity; and
updating mapping of a logical address and a physical address of user data.

20. A memory system comprising:
a memory device including memory blocks divided into an available area and a bad area; and
a controller configured to:
check an average block usage of the memory device in a predetermined period by monitoring an amount of data received from a host and an amount of data programmed into the memory device by a background operation of the memory device,
check a sum of block durability of the memory device on the basis of a maximum program/erase (P/E) cycle and a current P/E cycle of memory blocks included in the available area, and
determine a life expectancy of the memory device according to a current user capacity in the available area on the basis of the sum of the block durability and the average block usage.
